(19) United States
(12) Patent Application Publication
(10) Pub. No.: US 2012/0267446 A1
(43) Pub. Date: Oct. 25, 2012

(54) PUMP FOR DELIVERING A FLUID

(75) Inventors: Martin Stiegler, Beilstein (DE); Herbert Martin, Weinstadt-Beutelsbach (DE)

(73) Assignee: Duerr Systems GmbH, Bietigheim-Bissingen (DE)

(21) Appl. No.: 13/140,534

(22) PCT Filed: Dec. 2, 2009
(86) PCT No.: PCT/EP2009/008601

§ 371 Date: Jun. 17, 2011

(30) Foreign Application Priority Data
Dec. 19, 2008 (DE) 10 2008 063 983.4

(51) Int. Cl. B05B 1/26; F01D 15/12

(52) U.S. Cl. 239/11; 415/122.1; 239/518

(57) ABSTRACT

A pump, e.g., for delivering fluid, such as a metering pump for metering a coating agent in a coating system, is disclosed. An exemplary pump may include a pump inlet for feeding the fluid, a pump outlet for discharging the fluid, a rotatably supported drive shaft for mechanically driving the pump, and a coupling. The coupling may be structurally integrated in the pump, for mechanically connecting the drive shaft of the pump to an output shaft of a drive motor.

### CROSS-REFERENCES TO RELATED APPLICATIONS

This application is a National Stage application which claims the benefit of International Application No. PCT/EP2009/008601 filed Dec. 2, 2009, which claims priority based on German Application No. 10 2008 063 983.4, filed Dec. 19, 2008, both of which are hereby incorporated by reference in their entirety.

### BACKGROUND

The present disclosure relates to a pump for delivering a fluid such as, for example, a metering pump for metering a coating agent in a coating plant.

In modern coating plants for painting vehicle body parts, a gear pump is usually used as a metering pump to meter the paint to be applied whose structure is described, for example, in DE 10 2005 059 563 A1 and shown schematically in FIG. 3. The conventional gear pump 1 has two parallel front plates 2, 3 between which there is a middle plate 4, the middle plate 4 having recesses in it for two gears 5, 6 which engage with each other and pump the paint to be applied. The gear 5 is mounted in this conjunction on a shaft 7 and is driven by gear 6 with the shaft 7 being mounted in two bearings 8, 9 in the two front plates 2, 3. The other gear 6 is, on the other hand, mounted on a drive shaft 10 and is driven via a coupling 11 by a output shaft 12, the output shaft 12 being a connecting shaft which is driven via a further coupling by a drive motor 13. The output shaft 12 can consist here of an electrically insulating material in order to allow separation of potentials.

Output shaft 12 can generally also be a connecting shaft. The connecting shaft is primarily used for the drive on the robot arm, the drive motor being positioned at a distance of about 800 mm. In this way it is possible to achieve a small construction and the metering pump can be positioned near the atomizer using a short piece of hose. Furthermore, the connecting shaft can be designed as an insulating shaft. In this way it is possible to obtain separation of potentials between the pump, which has a high voltage applied to it, and the drive motor which is operating with the operating voltage or earth potential.

The drive shaft 10 for pump 1 is mounted in this case inside pump 1 on two bearings 14, 15 in both front plates 2, 3 of pump 1. Furthermore, there are two bearings 16, 17 outside the pump 1, the bearing 16 supporting the drive shaft 10 for pump 1 while bearing 17 supports the output shaft 12 of the drive motor 13. The coupling 11 between the drive motor 13 and the pump 1 is designed according to prior art, for example as a claw coupling, metal bellows coupling, curved teeth coupling or magnetic coupling.

One disadvantage of this conventional construction is, first of all, the fact that the external coupling 11 requires additional installation space which makes it more difficult to mount the whole assembly on a robot arm of a painting robot, since the installation space available there is quite limited.

One further disadvantage of this conventional construction with the external coupling 11 between the drive motor 13 and the gear pump 1 is due to the fact that the alignment inaccuracy of the output shaft 12 of the drive motor 13 relative to the drive shaft 10 of the gear pump 1 is passed on over a number of components (e.g. robot arm, holders, plates, etc.) so that the alignment inaccuracy is increased by the various component tolerances which can, in end effect, lead to mechanical tensions in the drive train between the drive motor 13 and the gear pump 1.

One should furthermore mention that the coupling 11 is usually a normally commercially available coupling which is, however, only available in certain sizes for the required drive torques, the required installation space being unnecessarily increased in size for the whole assembly.

Finally there is the risk with the above-mentioned conventional design that the gear pump 1 is replaced by a commercially available metering pump for a malfunction due to wear which does not meet the required technical specifications, whereby the operating safety of the painting plant can be endangered. This is because the coupling 11 is usually a normally commercially available coupling which can therefore also be connected with the drive shaft of any commercially available metering pumps.

Concerning the prior art one can furthermore refer to EP 1 343 971 B1, DE 10 2005 016 670 A1; DE 697 27 171 T2, DE 10 2005 008 920 A1 and DE 10 2005 031 832 A1.

It is therefore an object of the present disclosure to improve the above-mentioned conventional metering pump accordingly.

### BRIEF DESCRIPTION OF THE FIGURES

While the claims are not limited to the specific illustrations described herein, an appreciation of various aspects is best gained through a discussion of various examples thereof. Referring now to the drawings, illustrative examples are shown in detail. Although the drawings represent the exemplary illustrations, the drawings are not necessarily to scale and certain features may be exaggerated to better illustrate and explain an innovative aspect of an illustration. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1A illustrates a cross-sectional view of a metering pump, according to an exemplary illustration,

FIG. 1B illustrates a detailed view of the exemplary metering pump from FIG. 1A in the coupling area,

FIG. 2 illustrates a schematic diagram of a metering pump, according to an exemplary illustration,

FIG. 3 illustrates a schematic diagram of a conventional layout of a metering pump with an external coupling and an associated drive motor,

FIGS. 4A-4C illustrate a variant of an exemplary coupling with circular sector shaped drivers which form-fittingly interlock in each other,

FIG. 5A-5C illustrate another variant of an exemplary coupling with form-fittingly interlocking octagonal profiles,

FIGS. 6A-6C illustrate another variant of an exemplary coupling with driver pins which engage in corresponding receiving bores,

FIGS. 7A-7C illustrate a curved teeth coupling according to an exemplary illustration,

FIG. 8A illustrates a cross-sectional view of another exemplary metering pump with another type of coupling, and

FIG. 8B illustrates a perspective view of the coupling of the exemplary metering pump from FIG. 8A.

### DETAILED DESCRIPTION

The present disclosure includes the general technical teaching that the external coupling and/or the external bearings according to the prior art may be constructionally integrated into the pump, whereby the required installation space can be reduced.

In one exemplary illustration, the pump has a coupling constructionally integrated in the pump in order to connect the drive shaft of the pump with an output shaft of a drive motor. This may mean that the pump has a pump housing in which the coupling is placed so that the coupling housing protects the integrated coupling from getting dirty.

In another exemplary illustration, there is also provision for the bearing for the drive shaft of the pump, which is normally located outside the pump, to be constructionally integrated into the pump. The integrated bearing may be dimensioned in such a way that the integrated bearing is also sufficient to support the output shaft of the drive motor, so that the output shaft of the drive motor does not need any additional bearing between the pump and the drive motor. Accordingly, there may advantageously be absolutely no necessity to have additional bearings between the drive motor and the pump in the exemplary illustrations.

In one exemplary illustration, the integrated bearing can be any rolling bearing or sliding bearing that is convenient.

In another exemplary illustration, the drive shaft of the pump can be sealed on the pump side of the integrated bearing by at least one shaft sealing ring, as may be convenient.

An assembly angle may often be needed for conventional metering pumps to mount the pump on a substratum (e.g. a robot arm) whereby the constructional height of the pump in its mounted state is relatively large, which makes it more difficult to mount on a robot arm since the robot arm should usually be as slim as possible. Some exemplary illustrations, therefore, provide for a situation whereby the pump can be mounted without any additional holder with its underside directly onto a substratum, in particular onto a robot arm of a painting robot. This direct mounting of the pump without any additional holder advantageously allows a very small distance between the rotational axis of the drive shaft of the pump and the underside of the pump which lies directly on the mounting surface of the substratum. For example, it is possible that this distance between the rotational axis of the drive shaft for the pump and the mounting surface is less than 50 mm, 40 mm, 30 mm, 20 mm or even less than 10 mm. There is therefore the possibility, as part of some exemplary illustrations, that the distance between the rotational axis of the drive shaft of the pump and the mounting surface is less than the diameter of the drive shaft.

Mounting of the metering pump can also take place by means of a concentric clamping flange in the area of the bearing housing. It is fundamentally possible to consider all types of fastening options.

In one exemplary illustration, the coupling has a first coupling piece which is connected rotationally fixed with the drive shaft of the coupling and, in the coupled condition, creates a form-fit with a second coupling piece which is connected rotationally fixed with the output shaft of the drive motor. Both coupling pieces can therefore be connected in a form-fitting manner together and create a rotationally fixed, form-fitting, substantially damping free and non-shiftable connection between the output shaft of the drive motor and the drive shaft of the pump.

The two coupling pieces may be formed to be complementary to each other so that the first coupling piece can only be coupled with the respectively complementarily formed second coupling piece and creates a form-fit, not however with an output shaft without a correspondingly formed coupling piece. An exemplary pump can, therefore, not be replaced by a commercially available pump which does not have a correspondingly adapted coupling piece. This prevents replacement of the exemplary metering pumps by a commercially available metering pump for a malfunction due to wear which does not meet the required technical specifications and can therefore lead to endangerment the operating safety of the painting plant. The individual design of the exemplary couplings may therefore contributes to the operating safety of the painting plant.

For this reason the individual first coupling piece may be mounted inseparably on the drive shaft of the pump in order to prevent mounting of a conventional clamp coupling on the drive shaft.

The exemplary couplings may be designed in such a way that disassembly of the coupling with the intention to make a connection to a commercially available metering pump is not possible.

In one example of the coupling, both parts of the coupling respectively have on the front side circular sector shaped and axially projecting drivers which are taken up between correspondingly adapted circular sector shaped drivers of the respective other coupling part and create a form-fit. Thus when coupling together both coupling parts are pushed coaxially together until the circular sector shaped driver is introduced between the circular sector shaped driver of the respective other coupling part.

In another example, both coupling pieces have interlocking polygon profiles to create the form-fit. For example, a coupling piece can have an outer hexagonal profile while the other coupling piece can have a correspondingly adapted inner hexagonal profile. It is however possible, as an alternative, to have triangular, square, pentagonal, septagonal and octagonal profiles, merely as examples.

In another exemplary illustration, the one coupling part has an axially projecting driver pin which, in a coupled condition, engages in a correspondingly adapted axially extending receiving bore in the other coupling part. Two pairs of driver pins and receiving bores may advantageously be arranged diametrically to the rotational axis of the drive shaft.

Another example, a curved teeth coupling may be provided, where the one coupling part has an outer toothing and the other coupling part has a correspondingly adapted inner toothing which interlock with each other in the coupled condition.

It may be advantageous that the outer toothing and the inner toothing of both coupling parts are not made according to a standard, e.g., a standardized size, shape, or configuration, but are designed individually in order to prevent coupling with a conventional coupling, a point which may be meaningful for the security and safety considerations already mentioned above. An individual or unique design of the inner toothing or the outer toothing can therefore be realized in such a way, for example, that the outer or inner toothing has different sizes of teeth or gaps between the teeth distributed over the circumference. The curved teeth coupling of some exemplary illustration may therefore not fit together with conventional coupling pieces; thereby generally preventing any replacement of some exemplary metering pumps by a commercially available metering pump which does not correspond to the technical specifications.

In another exemplary illustration, the coupling has three coupling parts, wherein the first coupling part is connected rotationally fixed with the drive shaft of the pump while the second coupling part is connected rotationally fixed with the output shaft of the drive motor. The third coupling part is inserted between the first coupling part and the second coupling part and, in a coupled condition, creates a form-fit with the first coupling part and with the second coupling part.

This form-fit can, for example, be realized in that the first coupling part and the second coupling part has axially projecting claws on the front side which engage in the corresponding receiving means in the middle coupling part.

The two outer coupling parts may be formed integrally on the respective ends of the shaft, or may be formed by the respective shaft ends so that there is only one free coupling part there in the form of a connecting sleeve.

There is the possibility that the connecting sleeve could offer the coupling mechanical overload protection in order to avoid drive shaft damage due to overload conditions. In such a case the connecting sleeve would already break under torque conditions which the drive shaft could still withstand with an adequate margin of safety. For example, the connecting sleeve can have a mechanical loading capacity of 12-20 Nm.

Furthermore, the connecting sleeve may allow for an axial, radial and/or angular offset between the shafts.

Furthermore, according to one exemplary illustration, a coupling may be surrounded by an outer cover which protects the coupling from getting dirty. The outer covering may extend substantially coaxially to the drive shaft of the pump, the outer covering having an inserting opening in its distal end on the front side into which the output shaft of the drive motor can be introduced axially with the second coupling piece in order to couple the two coupling pieces together.

In this configuration the drive shaft of the pump with the first coupling piece may advantageously not project out in an axial direction from the outer covering in order to prevent mounting of a commercially available coupling.

One should mention that the outer covering of the coupling may have an internal diameter which has an oversize compared to the outer diameter of the first coupling piece or the drive shaft of the pump which is less than 10 mm, 5 mm or 2 mm. Furthermore, the inserting opening of the outer covering may have a clear diameter which has an oversize compared to the outer diameter of the first coupling piece or the drive shaft of the pump which is, in some exemplary illustrations, less than 10 mm, 5 mm or 2 mm. On the one hand this relatively small oversize prevents ingress of dirt into the outer covering in a coupled condition. On the other hand the relatively small oversize offers the advantage that it is much more difficult to replace the pump with a commercially available but unsuitable metering pump, thereby contributing to the operating safety of the painting plant.

The pump, according to an exemplary illustration, may be a rotary piston pump such as a gear pump. Any such gear pumps may be employed that are convenient, e.g. as described in the already cited patent application DE 10 2005 059 563 A1. The above-cited patent application DE 10 2005 059 563 A1 is, therefore, hereby expressly incorporated by reference in its entirety, including the above-noted description regarding the construction and mode of function of a gear pump.

The exemplary illustrations are not, however, limited to gear pumps but can also be realized with other types of pump such as wobble piston pumps, eccentric screw pumps and axial piston pumps, just to mention a few examples.

From the above description it is already quite clear that the exemplary pumps may be a metering pump whose delivery capacity is substantially independent of the pressure conditions at the pump inlet and the pump outlet.

It is furthermore self-evident that the pump for use in a painting plant that the pump may be resistant to solvents and/or paints.

It has already been mentioned above that the various exemplary metering pumps may in some cases be as small as possible in order to allow mounting on a slim robot arm of a painting robot. Therefore, in the case of the exemplary metering pumps, the integral coupling may advantageously not project in a radial direction relative to the drive shaft beyond the front plates of the gear pump, so the construction size of the exemplary metering pumps may not be increased through integration of the coupling into the pump.

One should also mention the fact that the coupling may be rotationally fixed, form-fitting, not shiftable, slip-free and/or substantially damping free.

In one exemplary illustration, a coupling may have an axial tolerance, for example, of at least 1 millimeter (mm), 2 mm, 5 mm or 10 mm. This means that the drive shaft of the pump and the output shaft of the drive motor have a corresponding axial relative freedom of movement.

Furthermore, in another exemplary illustration, a coupling can have an angular tolerance of at least 1°, 2°, 3°, 4° or 5°. This means that the drive shaft of the pump and the output shaft of the drive motor need not extend exactly parallel to each other but can include a corresponding angle.

Furthermore, one should mention the fact that the above-mentioned term or phrase integration of the coupling in the pump also includes the possibility that the coupling is located in a coupling housing flanged to the pump.

One should mention the fact that the exemplary illustrations are not limited to a pump as an individual component but can also include a corresponding coating device having such a pump.

The exemplary coating devices can, for example, be designed as a coating robot and, apart from the exemplary pumps described herein, also include a drive motor for the pump as well as an atomizer for application of the coating material being metered by the pump.

The pump may be mounted together with the drive motor in or on the distal or the proximal robot arm of the painting robot.

In another exemplary illustration, a coating device may be designed as a painting machine with a number of linear degrees of freedom of movement, for example as a so-called side machine or a roof machine for painting the side surfaces or the roof and hood surfaces of a motor vehicle body.

The exemplary illustrations also include the use of a corresponding pump for metering a coating agent in a coating plant.

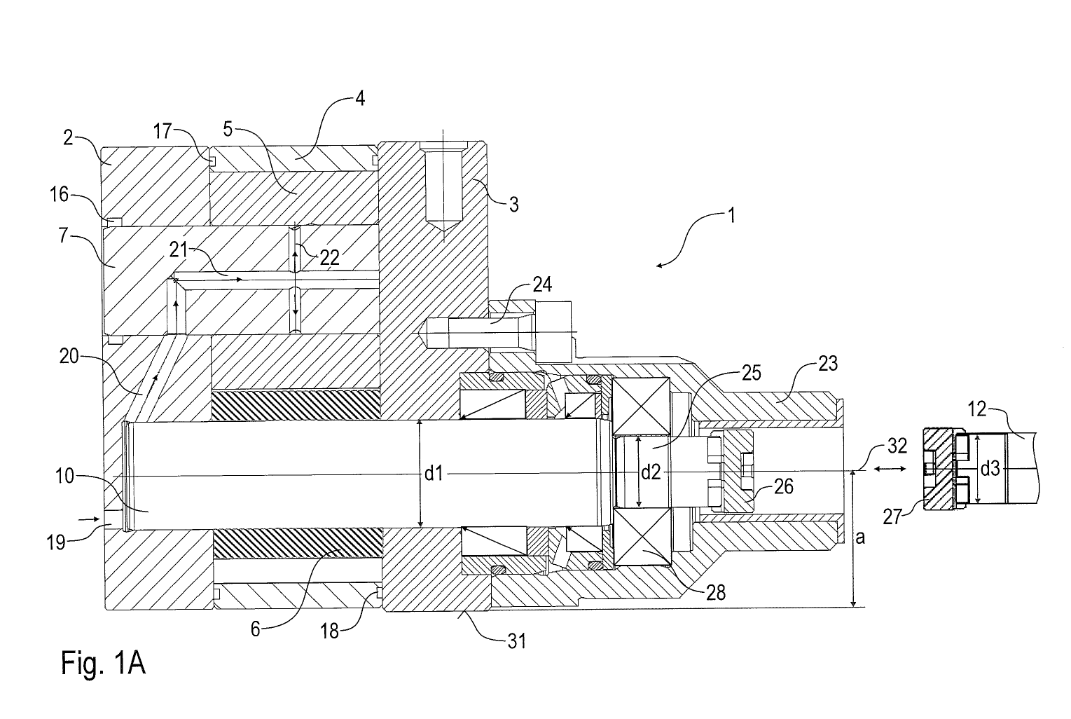

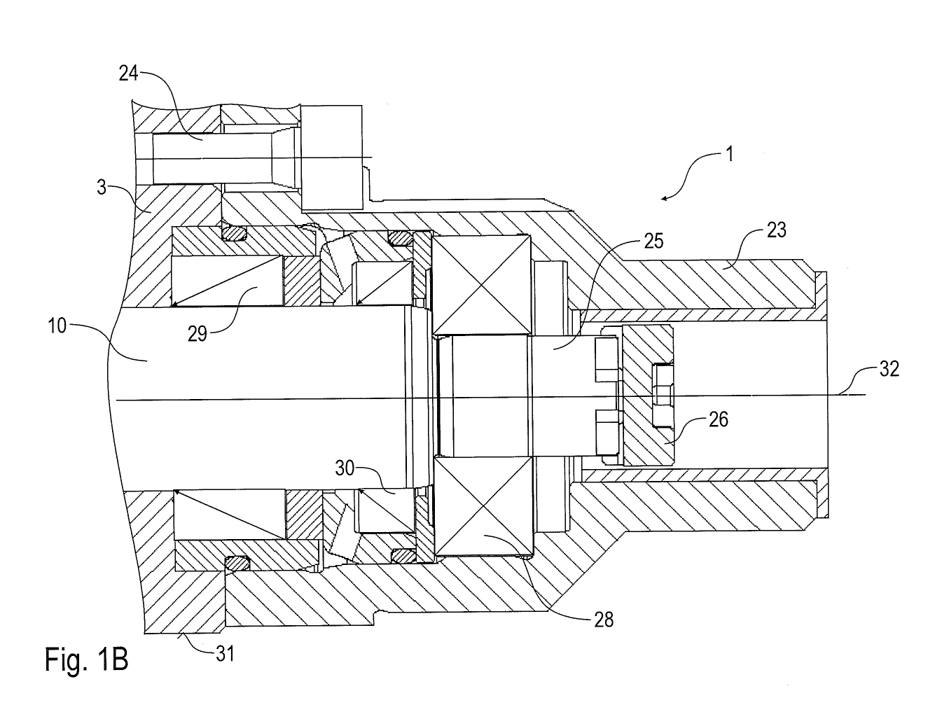

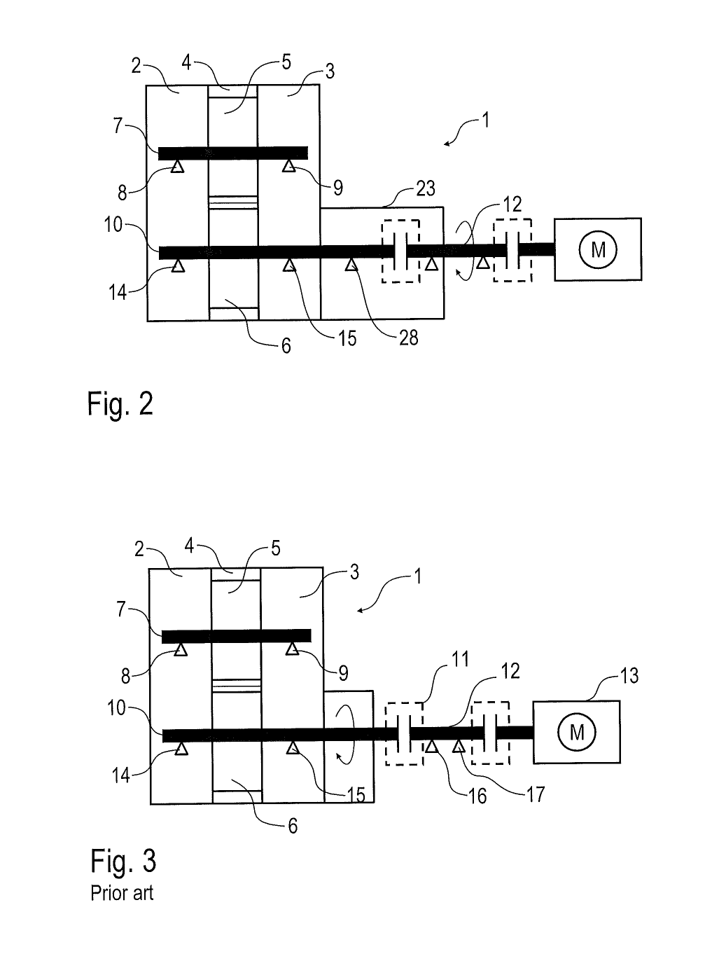

Turning now to FIGS. 1A and 1B, and exemplary gear pump 1 is illustrated. The gear pump 1 generally corresponds in part to the gear pump 1 described above and shown schematically in FIG. 3, so reference is made to the above description concerning FIG. 3 to avoid repetitions, wherein the same reference signs are used for corresponding details.

One should also mention that there may be a ring groove 16 located in the front plate 2 which receives a sealing ring not shown for simplicity which seals the shaft 7 against the associated bore in the front plate 2.

Furthermore, there may be corresponding ring grooves 17, 18 in the middle plate 4 respectively on the front side which each receive a sealing ring which is also not shown for simplicity. The sealing ring in the ring groove 17 seals the gap between the middle plate 4 and the front plate 2 while the sealing ring in the ring groove 18 seals the gap between the middle plate 4 and the front plate 3.

Furthermore, there may be a flushing agent bore 19 in the front plate 2 over which the flushing agent can be fed, wherein the fed lubricant is led via lubricant ducts 20, 21, 22 to the lubrication points.

In one exemplary illustration, there is a coupling housing 23 flanged to the front plate 3, the coupling housing 23 being screwed on using a number of screws 24 to the front plate 3.

The drive shaft 10 of the gear pump 1 may have a shaft piece 25 on its distal end with a step-shaped reduced diameter d2<d1, a coupling piece 26 being attached rotationally fixed to the distal end of the shaft piece 25. The coupling piece 26 creates a form-fit in a coupled condition with a correspondingly adapted coupling piece 27 which is connected rotationally fixed with the output shaft 12 of the drive motor 13.

The shaft piece 26 of the drive shaft 10 of the gear pump 1 may be supported within the coupling housing 23 in a rolling bearing 28, the rolling bearing 28 being dimensioned in such a way that one can dispense with the bearings 16, 17 that are required according to prior art according to FIG. 3 between the gear pump 1 and the drive motor 13.

Furthermore, the drive shaft 10 of the gear pump 1 between the rolling bearing 28 and the front plate 3 may be sealed by means of a number of shaft sealing rings 29, 30.

One should furthermore mention that the drive shaft 10 with the coupling piece 26 attached thereon does not, in one exemplary illustration, project out of the coupling housing 23 in an axial direction. On the one hand this will make it much more difficult for the coupling piece 26 to get dirty since the surrounding coupling housing 23 protects from dirt. On the other hand this will make it much more difficult to couple to conventionally designed output shafts without the coupling piece 27. It is however possible, as an alternative, that the coupling only has a single coupling part.

This may in some cases be advantageous, by making it much more difficult to replace the exemplary gear pump 1 with another pump, e.g., a commercially available metering pump, which does not meet the technical specifications, thereby contributing to the operating safety of the painting plant.

One should also mention the fact that the integration of the coupling in the gear pump 1 may allow a smaller constructional height. Thus the gear pump 1 in this exemplary illustration may be mounted with its underside 31 on a robot arm of a painting robot, wherein a distance between the underside 31 of the gear pump 1 and a rotational axis 32 of the drive shaft 10 can be less, merely as an example, than 30 mm. Therefore the exemplary gear pump 1 may allow a very slim robot arm due to its low constructional height.

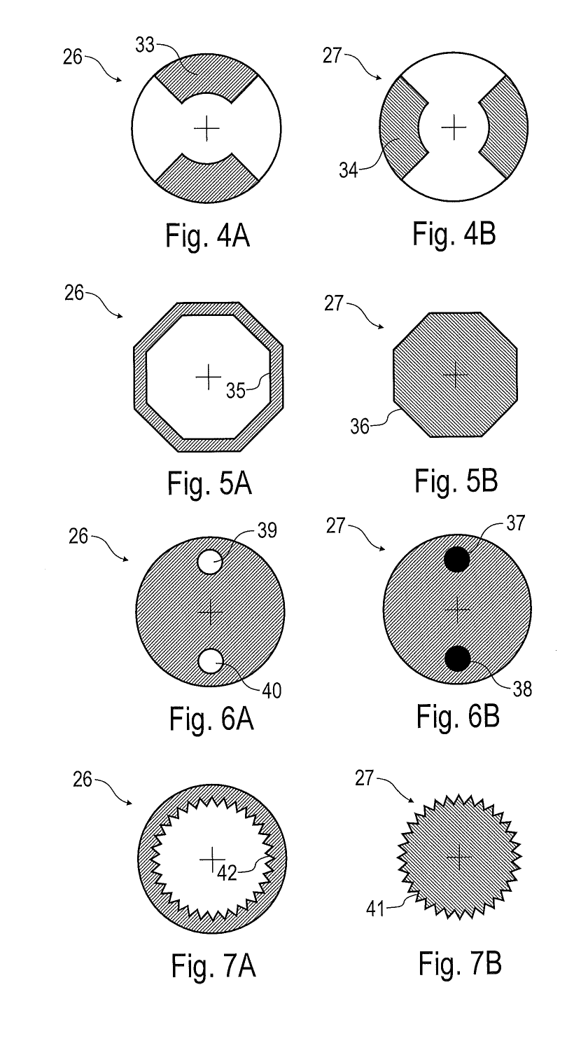

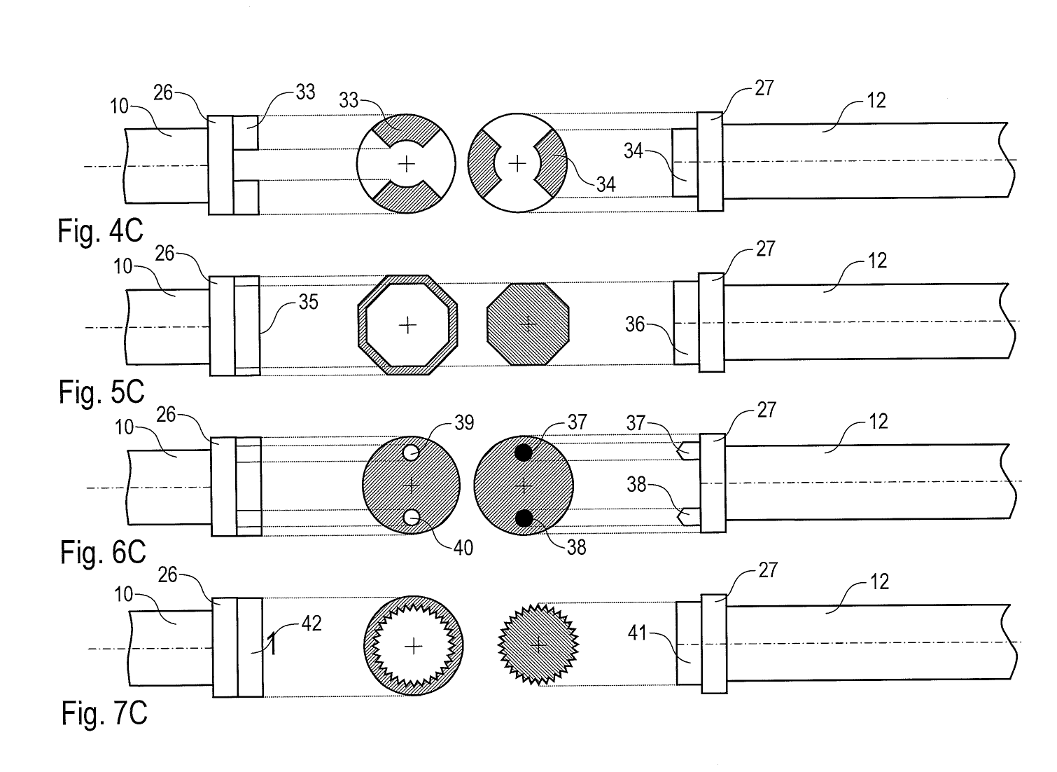

FIGS. 4A-4C show a variant of the exemplary coupling shown in FIGS. 1A and 1B. Both coupling pieces 26, 27 respectively may have an axially projecting, circular section shaped driver 33, 34 on the front side which interlock in each other in a coupled condition and create a form-fit connection.

FIGS. 5A-5C shows another exemplary illustration of a coupling. In this example, the coupling piece 26 has an inner octagonal profile 35 while the other coupling piece 27 has a correspondingly adapted outer octagonal profile 36, wherein the two profiles of the coupling pieces 26, 27 form-fittingly engage into each other in a coupled condition.

FIGS. 6A-6C show another exemplary illustration of a coupling, on which two axially protruding driving pins 37, 38 are located on the coupling piece 27 which engage in a coupled condition in correspondingly adapted axially extending receiving bores 39, 40 in the other coupling piece 26 and thereby produce a form-fitting, rotationally fixed connection.

FIGS. 7A-7C show a further exemplary illustration of a coupling in the form of a curved teeth coupling. The coupling piece 27 in this case has an outer toothing 41 which, in a coupled condition, engages in a correspondingly adapted inner toothing 42 of the other coupling piece 26.

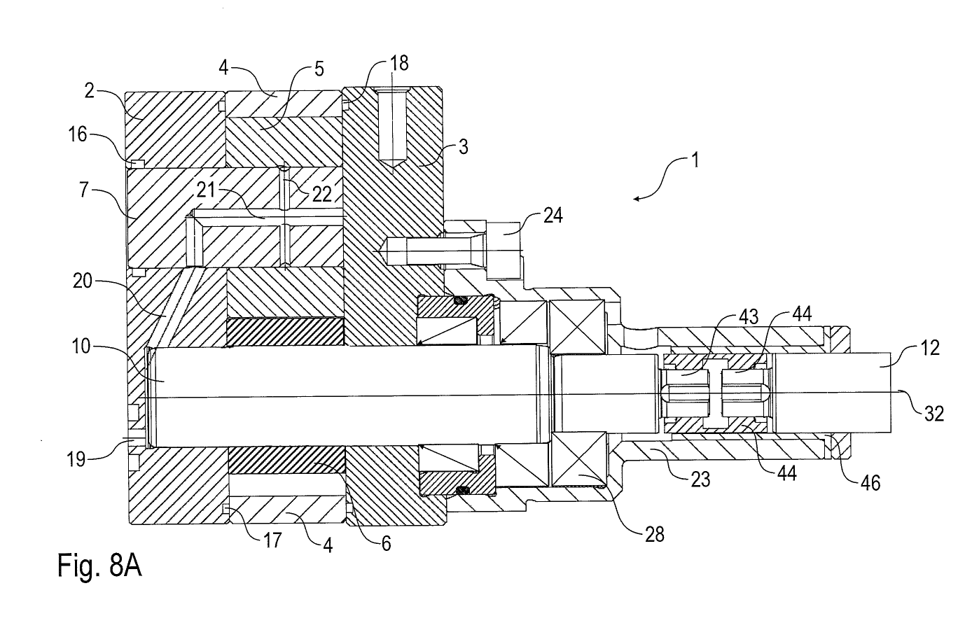

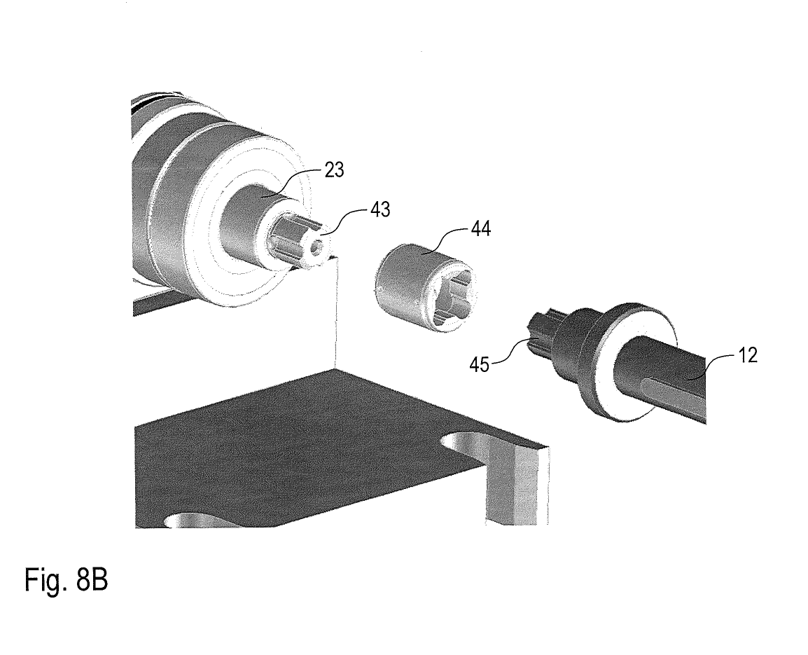

FIGS. 8A and 8B show another exemplary illustration of a gear pump 1, corresponding substantially to the example described above and shown in FIGS. 1A and 1B, so reference is made to the above description to avoid repetitions, wherein the same reference signs are used for corresponding details.

In one exemplary illustration, the coupling for connecting the drive shaft 10 with the output shaft 12 generally includes three coupling parts 43, 44, 45. The coupling part 43 may be connected rotationally fixed to the drive shaft 10 of gear pump 1, while coupling part 45 is connected rotationally fixed to the output shaft 12 of the drive motor 13.

The coupling piece 44 may be inserted between both coupling pieces 43, 45 and may be in the coupled condition form-fittingly connected with the coupling pieces 43, 45 so that the coupling piece 44 creates a form-fitting connection between both coupling pieces 43, 45. To do this both coupling pieces 43, 45 may have four axially extending ribs distributed over the circumference, which engage in corresponding axially extending grooves distributed over the circumference in the coupling piece 44, thereby producing a rotationally fixed connection.

One should furthermore mention the fact that a bearing bush 46 may be inserted in the coupling housing 23, where the bearing bush 46 offers the function of a sliding bearing for the coupling piece 44.

The exemplary illustrations are not restricted to the above-described examples. Rather, a large number of variants and modifications are possible, which also make use of the inventive ideas and therefore come under the scope of protection. The exemplary illustrations in particular also include useful features, e.g., as described in the subject-matter of the individual dependent claims, independently of other features, e.g., as described in other claims.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be evident upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “the,” etc. should be read to recite one or more of the indicated elements unless a claim recites an explicit limitation to the contrary.

### REFERENCE LIST

| | |
|---|---|
| 1 | Gear pump |
| 2 | Front plate |
| 3 | Front plate |
| 4 | Middle plate |
| 5 | Gear |
| 6 | Gear |
| 7 | Shaft |
| 8 | Bearing |
| 9 | Bearing |
| 10 | Drive shaft |
| 11 | Coupling |
| 12 | Output shaft |
| 13 | Driver motor |
| 14 | Bearing |
| 15 | Bearing |
| 16 | Ring groove |
| 17 | Ring groove |
| 18 | Ring groove |
| 19 | Flushing agent bore |
| 20 | Lubricant duct |
| 21 | Lubricant duct |
| 22 | Lubricant duct |
| 23 | Coupling housing |
| 24 | Screw/bolt |
| 25 | Shaft piece |
| 26 | Coupling piece |
| 27 | Coupling piece |
| 28 | Rolling bearing |
| 29 | Shaft sealing ring |
| 30 | Shaft sealing ring |
| 31 | Underside |
| 32 | Rotational axis |
| 33 | Driver |
| 34 | Driver |
| 35 | Inner octagonal profile |
| 36 | Outer octagonal profile |
| 37 | Driver pin |
| 38 | Driver pin |
| 39 | Receiving bore |
| 40 | Receiving bore |
| 41 | Outer toothing |
| 42 | Inner toothing |
| 43 | Coupling part |
| 44 | Coupling part |
| 45 | Coupling part |
| 46 | Bearing bush |

1. A pump for delivering a fluid, comprising:
a rotatably supported drive shaft for mechanical drive of the pump, and
a coupling constructionally integrated into the pump, for the coupling mechanically connection connecting the drive shaft of the pump with an output shaft.

2.-23. (canceled)

24. The pump according to claim 1, further comprising a bearing constructionally integrated in the pump, the bearing supporting the drive shaft of the pump a.

25. The pump according to claim 24, wherein the integrated bearing is dimensioned in such a way that the integrated bearing is also adequate for supporting the output shaft of the drive motor so that the output shaft of the drive motor does not need any additional bearing between the pump and the drive motor.

26. The pump according to claim 24, wherein the integrated bearing includes a rolling bearing or a sliding bearing.

27. The pump according to claim 24, wherein the drive shaft of the pump on the pump side of the integrated bearing is sealed by at least one shaft sealing ring.

28. The pump according to claim 1, wherein the external output shaft is supported in a sliding bearing.

29. The pump according to claim 1, wherein the pump is configured to be mounted with its underside directly on a substratum without use of an additional holder.

30. The pump according to claim 1, wherein the distance between the rotational axis of the drive shaft of the pump and the underside of the pump is less than the diameter of the drive shaft.

31. The pump according to claim 1, wherein the coupling has a first coupling piece which is connected rotationally fixed with the drive shaft of the pump and in a coupled condition creates a form-fit with a second coupling piece which is connected rotationally fixed with the output shaft of the drive motor.

32. The pump according to claim 31, wherein the two coupling pieces are formed complementary so that the first coupling piece can only be coupled with the correspondingly complementarily formed second coupling piece and creates a form-fit, but not, on the other hand, with an output shaft without a correspondingly formed coupling piece.

33. The pump according to claim 31, wherein the first coupling piece is mounted inseparably on the drive shaft of the pump in order to prevent mounting of a clamp coupling on the drive shaft.

34. The pump according to claim 31, wherein both coupling parts each have circular sector formed and axially projecting drivers on the front side which are received between correspondingly adapted circular sector formed drivers of the respective other coupling part and create a form-fit.

35. The pump according to claim 31, wherein both coupling parts have interlocking polygon profiles for creating a form-fit.

36. The pump according to claim 31, wherein the both coupling parts have at least one axially projecting driver pin and at least one correspondingly axially extending receiving bore which interlock in a coupled condition for creating a form-fit.

37. The pump according to claim 31, wherein the coupling includes a curved teeth coupling, the one coupling piece having an outer toothing and the other coupling piece having a correspondingly adapted inner toothing.

38. The pump according to claim 37, wherein:
the outer toothing of the one coupling piece and the inner toothing of the other coupling piece are not designed according to a standardized configuration, thereby preventing coupling with a conventional coupling having the standardized configuration, and the outer toothing has different sized teeth distributed over the circumference and the inner toothing is adapted correspondingly and has different sized tooth gaps distributed over the circumference.

39. The pump according to claim 1, wherein
a) the coupling has a first coupling part which is connected rotationally fixed with the drive shaft of the pump, and
b) the coupling has a second coupling part which is connected rotationally fixed with the output shaft of the drive motor, and
c) the coupling has a third coupling part which is inserted between the first coupling part and the second coupling part and creates a form-fit in a coupled condition with the first coupling part and the second coupling part,
d) the first coupling part is formed integrally on the drive shaft,
e) the second coupling part is formed integrally on the output shaft.

40. The pump according to claim 39, wherein
a) the first coupling part has axially projecting claws on the front side,
b) the second coupling part has axially projecting claws on the front side,
c) the third coupling part has receiving means for the claws of the first coupling part and the second coupling part.

41. The pump according to claim 1, wherein
a) the coupling is surrounded by an outer cover which prevents the coupling from getting dirty,
b) the outer cover extends substantially coaxially to the drive shaft of the pump,
c) the outer cover has an inserting opening on its distal end on the front side in which the output shaft of the drive motor can be introduced axially with the second coupling part in order to couple both coupling parts together.

42. The pump according to claim 41, wherein the drive shaft of the pump does not project out of the outer cover with the first coupling part in an axial direction in order to prevent mounting of a conventional coupling.

43. The pump according to claim 41, wherein the outer cover of the coupling has an internal diameter which has an oversize compared to the outer diameter of the first coupling part which is less than 10 mm.

44. The pump according to claim 41, wherein the inserting opening of the outer cover has a clear diameter which has an oversize compared to the outer diameter of the first coupling part which is less than 10 mm.

45. The pump according to claim 1, wherein the pump is a rotary piston pump.

46. The pump according to claim 1, wherein the pump is a metering pump and has a delivery capacity which is substantially independent of the pressure condition between a pump inlet and a pump outlet.

47. The pump according to claim 1, wherein the pump is resistant to solvents and paint.

48. The pump according to claim 1, wherein the pump is a gear pump.

49. The pump according to claim 48, wherein
a) the gear pump has two front plates between which two interlocking pump gears are arranged which are driven by the drive shaft,
b) the integrated bearing for the drive shaft of the pump is arranged outside both front plates and within the pump,
c) the coupling does not project out in a radial direction concerning the drive shaft over the front plates of the gear pump.

50. The pump according to claim 1, wherein the coupling is selected from a group consisting of:
a) rotationally fixed coupling,
b) form-fitting coupling,
c) non-shiftable coupling,
d) substantially damping free coupling,
e) coupling having an axial tolerance of at least 1 mm,
f) coupling having an angular tolerance of at least 1°.

51. The pump according to claim 1, wherein
a) the coupling is arranged inside a coupling housing and
b) the coupling housing is flanged to the pump.

52. The pump according to claim 1, wherein the pump is a metering pump for metering a coating agent in a coating plant.

53. A coating device, comprising:
an atomizer for application of a coating agent,
a pump for supplying the atomizer with the coating agent and
a drive motor for driving the pump, wherein the pump is a pump according to claim 1.

54. The coating device according to claim 53, designed as a multi-axis painting robot with many robot arms which can swivel relative to each other which guide the atomizer.

55. The coating device according to claim 53, designed as a painting machine which has a number of linear degrees of freedom of movement.

56. The coating device in the form of a painting robot according to claim 54, wherein the pump and the drive motor are mounted together in or on the distal robot arm.

57. The coating device in the form of a painting robot according to claim 54, wherein the pump and the drive motor are mounted together in or on the proximal robot arm.

58. The coating device according to claim 53, wherein the pump is with its underside directly mounted on a robot arm without any additional holder.

59. The coating device according to claim 53, wherein the distance between the rotational axis of the drive shaft of the pump and a robot arm is less than 50 mm.

60. The coating device according to claim 53, wherein the distance between the rotational axis of the drive shaft of the pump and a robot arm is less than the diameter of the drive shaft.

61. The coating device according to claim 53, wherein
a) the drive shaft of the pump outside the pump does not have an additional bearing,
b) the output shaft outside the drive motor does not have an additional bearing,
c) the drive shaft of the pump and the output shaft between the pump and the drive motor do not have a bearing.

62. The coating device according to claim 53, wherein the coating device is a painting robot for painting motor vehicle body parts.

63. Use of a pump according to claim 1 for metering a coating agent in a coating plant.
